(19) United States
(12) Patent Application Publication
(10) Pub. No.: US 2025/0029634 A1
(43) Pub. Date: Jan. 23, 2025

(54) SYSTEM FOR THE PRODUCTION OF A MOVIE USING AN APPLICATION

(71) Applicant: Roger Janik, Conroe, TX (US)

(72) Inventor: Roger Janik, Conroe, TX (US)

(21) Appl. No.: 18/760,096

(22) Filed: Jul. 1, 2024

Related U.S. Application Data
(60) Provisional application No. 63/514,468, filed on Jul. 19, 2023.

(51) Int. Cl. G11B 27/031; G06Q 20/04; G06Q 30/0207; H04N 5/262

(52) U.S. Cl. CPC G11B 27/031; G06Q 20/0457; G06Q 30/0207; H04N 5/2624

(57) ABSTRACT

A movie production system including hardware for running the system and a movie stitching algorithm. The movie stitching algorithm includes a direct algorithm for guiding directors in the production of a movie, an act algorithm for users to participate in open-call casting, claiming scenes and contributing in user created film portions, a compete algorithm for providing daily acting competition for the users, an interact algorithm for allowing the director to create a director's cut and for users to add content or plot twists and an automated post-production algorithm for applying the director chosen post-production features, including background music, scene transitions, background images, and filters. The movie creation system is an advanced movie-stitching system which combines individual scenes submitted by actors following the sequence laid out by a director during the production process.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application claims the benefit of U.S. Provisional Patent Application No. 63/514,468 filed on Jul. 19, 2023, which is incorporated by reference herein in its entirety.”

### BACKGROUND OF THE INVENTION

### Field of the Invention

The invention relates generally to the production of movies and, more particularly, to the production of movies using software running on a personal mobile device or other computer device.

### Description of Related Art

Traditional short film creation is a multifaceted and costly process. Before even considering filming, directors and producers must invest significant time and resources into pre-production activities like casting, location scouting, arranging wardrobe, setting up lighting, and securing camera equipment. These activities not only add to the complexity and time consumption of the process but also inflate the budget considerably. Costs for producing a short film traditionally can escalate quickly. It is not uncommon for a finished minute of film to cost between $700 and $1,500. For a short film of 5 minutes this could mean a total production cost of up to $7,500. These financial burdens can act as significant barriers for creators who have stories to tell but lack the necessary resources. Beyond financial considerations, time is another significant challenge in traditional short film creation. With all the components involved, from pre-production to actual filming and post-production editing, it could take several weeks to produce a short film ready for public viewing.

What is needed is a system for addressing these pain points by offering a free platform where movies can be created in a dramatically reduced time frame, from as little as 1 hour to about 24 hours.

The problem is that traditional short film creation is a multifaceted and costly process. Before even considering filming, directors and producers must invest significant time and resources into pre-production activities like casting, location scouting, arranging wardrobe, setting up lighting, and securing camera equipment. These activities not only add to the complexity and time consumption of the process but also inflate the budget considerably.

This efficient approach stands in stark contrast to the weeks of work that traditional short film production demands, opening film creation to a broader audience and facilitating a level of creativity and collaboration previously unattainable.

### SUMMARY OF THE INVENTION

### Mobile Video Creation and Collaboration

This efficient approach stands in stark contrast to the weeks of work that traditional short film production demands, opening film creation to a broader audience and facilitating a level of creativity and collaboration previously unattainable. The system is structured around four main features that offer users multiple paths to participation and creativity: Direct: The Direct feature of the system app guides users in creating their unique produced movie, leveraging AI-powered tools for generating ideas and pre-selecting post-production elements. Act: The Act feature enables users to participate in open-call casting, claiming scenes and contributing their filmed parts to the final produced movie, showcasing their talent and fostering collaboration. Compete: The Compete feature offers a daily acting competition where users can engage in randomized scenes, with public voting determining the top five movies and scenes, driving participation and recognition. Interact: The app introduces user-centric features, allowing Directors to create a Director's Cut and users to add plot twists, resulting in multiple versions of a produced movie and promoting creativity and interaction.

Further, the Mozaik app utilizes AI-powered tools and automation to enhance the filmmaking process for its users. For example, Mozaik leverages advanced AI-powered tools to enhance the creative process for users. Directors can utilize AI to generate movie scripts and ideas, providing a strong starting point for their projects. This feature is particularly beneficial for those who may need inspiration or are new to scriptwriting. Additionally, the app automates many aspects of post-production, including film stitching, background music application, scene transitions, and filter effects. This automation ensures a professional finish for every Mozaik Movie without the need for specialized skills, significantly lowering the barriers to high-quality short film creation. These AI-driven and automated processes streamline the entire filmmaking journey, making it more accessible and efficient for users worldwide.

In other implementations, a Cloning feature in the Mozaik app allows users to replicate an existing Mozaik movie script and create different versions of the same movie. For example, this feature enables directors to take an original script, adjust scenes, cast new actors, and proceed with production, leading to multiple interpretations of the same story. The cloned movies can be further customized with various post-production elements such as background music, filters, and scene transitions, enhancing the uniqueness of each version. This Cloning feature fosters creativity and diverse storytelling by allowing directors to experiment with different artistic directions and casting choices, thereby adding flexibility and innovation to the filmmaking process.

The System app is powered by proprietary software technology that not only handles the creation and assembly of produced movies but also enriches the overall user experience with a host of intelligent and interactive features.

At the heart of the system app is an advanced movie-stitching algorithm. This innovative technology seamlessly combines individual scenes submitted by actors into a coherent whole, following the sequence laid out by the Director during the creation process.

The app also includes automated post-production functionality. Once the scenes are stitched together, the software auto-applies the Director's chosen post-production features, including background music, scene transitions, background images, and filters. This feature simplifies the post-production process and ensures a professional finish for every produced movie.

Once a movie is complete, the software auto-posts it to the public feed and simultaneously alerts the Director and actors that their produced movie is ready for viewing. A link is provided for immediate access, creating an exciting moment of unveiling for all participants.

To ensure a safe and inclusive environment, the system app incorporates content moderation services provided by a third-party. This integration leverages AI-based systems to automatically screen and filter out harmful content. Additionally, the system ensures that content displayed to users is age-appropriate, differentiating between users aged 12 and under and those 13 and older.

Post-release, directors have the option to create a ‘Director's Cut,’ a well-known concept in traditional filmmaking. Leveraging our proprietary technology, Directors can revisit their original produced movie and refine it to better align with their vision, thus producing a revised version of the film. The ‘Fan Twist,’ however, is a truly innovative feature unique to the system app. This interactive feature enables any user to reinterpret the original movie by adding an extra scene either at the beginning, at the end, or both, thereby creating their own version of a prequel, sequel, or even a ‘side story.’ This is accomplished using our unique software that seamlessly integrates these additional scenes into the original produced movie structure. These innovations, made possible through the application of our unique technology, can generate multiple versions of a single produced movie—the Original release, the Director's Cut, and numerous Fan Twists, further fueling engagement and creativity within the platform.

A unique feature of the system app is its in-app economic system, powered by the app's digital currency—the access ticket. Users can earn or purchase access tickets to use within the app ecosystem.

In addition, users can purchase digital gifts using special tickets for using the system, adding another layer of interaction and fun to the app. The special tickets may be referred to as access tickets. By integrating an in-app currency, the system app not only incentivizes participation and interaction but also establishes an internal economy that allows users to assign value to their engagements and rewards within the platform Directors can use these tickets to entice top actors or influencers to star in their produced movies. This not only provides Directors with a tool to attract talent but also offers a way for actors and influencers to monetize their participation.

Furthermore, users can show appreciation for their favorite produced movies by gifting tickets to the cast. The gifting system operates on an equitable distribution mechanism. When a gift is given to a produced movie, the Director receives 25% of its value, while the remaining 75% is evenly divided among the actors. This encourages a sense of community, recognizes effort and creativity, and fosters an atmosphere of mutual appreciation within the platform.

Overall, the system app merges proprietary coding with integrated third-party services to deliver a unique, accessible, and immersive platform for global movie collaboration.

The system app is a transformative mobile application that disrupts traditional short film creation processes, dramatically reducing the time and cost typically associated with producing a short film. By facilitating global collaboration and automating post-production elements, the system app empowers users to create a complete short film, known as a produced movie, in as little as one hour. This innovative approach leverages worldwide casting, automatic film stitching, and post-production enhancements to make short film creation more accessible and efficient than ever before.

In the age of digital content creation, the process of creating a short film remains surprisingly time-consuming and expensive. Traditional production methods demand significant resources, including crew hiring, location scouting, post-production editing, and more. These hurdles often prevent talented individuals from realizing their creative visions. Recognizing this gap, the present invention significantly simplifies and accelerates the process of short film creation.

The system app leverages the power of global collaboration, allowing anyone in the world to contribute to a produced movie project. Directors build each scene of the produced movie and then simultaneously cast actors for individual scenes. Directors also have the option to post open scenes on a public page for any Actor to claim. Actors then shoot and upload their filmed parts directly to the app. This collaborative approach not only democratizes the film creation process but also dramatically reduces the time required to produce a short film.

However, the innovation doesn't stop at collaboration. The system app also streamlines post-production. After each scene is uploaded, the app automatically stitches the film together, applies background music, scene transitions, background images, filters, and then posts the finished produced movie to a public feed. This feature significantly reduces the need for specialized editing skills and software, further breaking down barriers to short film creation.

The production system is structured around four main features that offer users multiple paths to participation and creativity:
1. Direct: The Direct feature of the system app incorporates an intuitive wizard that guides a director through the comprehensive process of creating their unique produced movie. As part of this process, the Director can leverage an AI-powered tool to generate movie ideas or scripts, providing a strong starting point for the creative journey.

Beyond merely defining the movie's scenes (maximum of 30 seconds per scene), the Direct feature enables directors to pre-select elements for the movie's post-production phase, such as background music, background image, scene transitions, and filter effects. These selections form a kind of post-production template that our proprietary software will later use to automatically complete the post-production once all scenes have been shot and uploaded by the actors.

After laying out the scenes and setting the post-production template, directors then cast each role to actors simultaneously. The casting process can be closed, with specific actors in mind, or open-ended, allowing for a broad call to any potential actor using the platform. This is achieved by posting the available roles on the public ACT page. The Direct feature thus provides a streamlined and efficient method for short film creation, from initial idea to final production.
2. Act: The Act feature invites users to engage in open-call casting, where Directors have opted to involve the public. Users can peruse available roles, “claim” an unclaimed scene, and submit their filmed parts for integration into the final produced movie. This feature provides aspiring actors with a platform to showcase their talent and contribute to diverse projects.
3. Compete: The Compete feature adds a level of excitement and motivation with a daily competition. Users can choose to participate in a randomized scene for the daily produced movie, crafted by system administrators. After users complete their scenes and upload, they are notified when the movie is complete for viewing. Over the following 24 hours, the public votes on all submitted produced movies. At the end of the voting period, the top five produced movies and top five scenes are announced on the Daily Awards page, providing recognition for the winners, and encouraging continued participation.
4. Interact: The app also introduces unique user-centric features to enhance engagement. Post-release, Directors have the option to create a Director's Cut version of the movie, giving them an opportunity to revisit and refine their vision. Additionally, any user can add a plot twist to the movie by inserting a scene at the beginning or end, effectively creating a prequel, sequel, or both. This ‘Fan Twist’ feature allows for creative reinterpretations of the original movie and can generate multiple versions of a single produced movie—the Original, the Director's Cut, and the Fan Twist.

By integrating these four main features, the system app not only simplifies and democratizes short film creation but also fosters a global community of creative individuals collaborating on a shared platform.

### Benefits & Advantages

The system app offers numerous benefits over traditional short film production methods. By leveraging global collaboration, simplifying the creation process, and removing cost barriers, the app allows users to focus on their creative visions instead of logistical and financial hurdles.

A unique aspect of the system app is its integrated in-app economy. Users can earn or purchase produced movie Tickets, the app's currency, and use them to show appreciation for their favorite produced movies. They can gift these tickets to the cast members of any movie they like, fostering a sense of recognition and reward for creativity and effort.

Furthering the interactive nature of the app, Directors have the option to use access tickets as an incentive to entice top actors or influencers to star in their produced movies. This functionality not only provides Directors with a tool to attract high-profile talent but also offers a viable avenue for actors and influencers to monetize their participation.

To add an element of fun and engagement, users can also purchase digital gifts with access tickets. These gifts can be given to their favorite cast members, further fueling the sense of community and encouragement within the platform.

What sets the economy of the present invention apart is its equitable distribution system. When a gift is given to a produced movie, the Director receives 25% of its value, while the remaining 75% is divided equally among the Actors. This system not only rewards the Director for their creative vision and coordination but also acknowledges the critical role each actor plays in bringing the movie to life.

In conclusion, the system app provides a platform for creative expression, global collaboration, and fair recognition of efforts. It breaks down the barriers to short film creation, making it accessible to anyone with a story to tell.

### Technical Details/how it Works

The system app is powered by proprietary software technology that handles the creation and assembly of produced movies and enriches the overall user experience with a host of intelligent and interactive features.

At the heart of the system app is an advanced movie-stitching algorithm which seamlessly combines individual scenes submitted by actors into a coherent whole, following the sequence laid out by the Director during the creation process.

The app also includes automated post-production algorithms. Once the scenes are stitched together, the software auto-applies the Director's chosen post-production features, including background music, scene transitions, background images, and filters. This feature simplifies the post-production process and ensures a professional finish for every produced movie.

Once a movie is complete, the software auto-posts it to the public feed and simultaneously alerts the Director and actors that their produced movie is ready for viewing. A link is provided for immediate access, creating an exciting moment of unveiling for all participants.

To ensure a safe and inclusive environment, the system app incorporates content moderation services provided by a third-party. This integration leverages AI-based systems to automatically screen and filter out harmful content. Additionally, the system ensures that content displayed to users is age-appropriate, differentiating between users aged 12 and under and those 13 and older.

Post-release, directors have the option to create a ‘Director's Cut,’ a well-known concept in traditional filmmaking. Leveraging our proprietary technology, Directors can revisit their original produced movie and refine it to better align with their vision, thus producing a revised version of the film.

The ‘Fan Twist,’ however, is a truly innovative feature unique to the system app. This interactive feature enables any user to reinterpret the original movie by adding an extra scene either at the beginning, at the end, or both, thereby creating their own version of a prequel, sequel, or even a ‘side story.’ This is accomplished using our unique software that seamlessly integrates these additional scenes into the original produced movie structure.

These innovations, made possible through the application of our unique technology, can generate multiple versions of a single produced movie—the Original release, the Director's Cut, and numerous Fan Twists, further fueling engagement and creativity within the platform.

A unique feature of the system app is its in-app economic system, powered by the app's digital currency—the access ticket. Users can earn or purchase access tickets to use within the app ecosystem.

Directors can use these tickets to entice top actors or influencers to star in their produced movies. This not only provides Directors with a tool to attract talent but also offers a way for actors and influencers to monetize their participation.

Furthermore, users can show appreciation for their favorite produced movies by gifting tickets to the cast. The gifting system operates on an equitable distribution mechanism. When a gift is given to a produced movie, the Director receives 25% of its value, while the remaining 75% is evenly divided among the actors. This encourages a sense of community, recognizes effort and creativity, and fosters an atmosphere of mutual appreciation within the platform.

In addition, users can purchase digital gifts using access tickets, adding another layer of interaction and fun to the app.

By integrating an in-app currency, the system app not only incentivizes participation and interaction but also establishes an internal economy that allows users to assign value to their engagements and rewards within the platform.

Overall, the system app merges proprietary coding with integrated third-party services to deliver a unique, accessible, and immersive platform for global movie collaboration.

The potential market for the system app is vast and diverse, given the app's multifaceted functionality and its appeal to a wide range of users.

ASPIRING FILMMAKERS AND DIRECTORS: The system app offers a robust platform for budding filmmakers and directors to create short films without the need for heavy investment in terms of time, money, or resources. It's a unique tool that democratizes the filmmaking process, thus attracting this user segment.

ACTORS AND INFLUENCERS: The app offers a platform for actors and influencers to showcase their talent to a global audience, gain visibility, and even monetize their performances using access tickets. It's an attractive option for those looking to build their portfolios or engage with their followers in a unique way.

EXISTING SOCIAL MEDIA VIDEO CONTENT CREATORS: Existing social media users, particularly those who frequently create and post video content on platforms like TikTok, Facebook, Instagram, and YouTube, represent a key user segment. With their established habit of creating and sharing videos, they are well-positioned to adopt the system platform and leverage its unique features for collaborative filmmaking and enhanced audience engagement.

GENERAL PUBLIC/ENTHUSIASTS: For the general public and movie enthusiasts, the system app offers an opportunity to participate in movie making, either through acting in open scenes or voting on their favorite produced movies in daily competitions. This active involvement in the creation process, coupled with the thrill of competition, makes the app appealing to a wide array of users.

In terms of geographical market, the potential is global. With the rise of social media and digital content consumption, short films and video content are increasingly popular across the globe. The system app taps into this trend, offering a new twist to the world of digital storytelling.

The system app may revolve around leveraging the existing ecosystems of video content creation on popular social media platforms.

The system targets short film creators active on major social media platforms. This niche group provides a fertile ground for early adoption of the system app. By tailoring our approach to their specific needs, we can attract these creators with a more efficient, cost-effective, and community-driven solution for short film creation.

The system app significantly reduces the logistical hurdles involved in traditional film production, such as location scouting and scheduling. Furthermore, with the added potential for global collaboration, the app broadens the creative possibilities for short film creators by providing access to diverse acting talents from around the world.

As these creators migrate to our platform and begin to produce innovative produced movies, we anticipate they will not only establish our credibility within this community but also serve as a beacon to attract a broader audience. The short films produced will act as a testament to the unique capabilities of the system app, making this a powerful beachhead strategy for our market entry.

INFLUENCER & MICRO-INFLUENCER PARTNERSHIPS: The system may build strong alliances with influencers and micro-influencers who consistently produce video content. These individuals have already established trust and rapport with their followers, making them ideal candidates for introducing the system app to potential users. By working in tandem with these influencers, we can effectively showcase the unique features and benefits of the system app, thereby catalyzing app adoption and user engagement. Through these partnerships, the system can reach a wider audience—from the large followings of influencers to the highly engaged niche communities cultivated by micro-influencers. This strategy provides a strong, scalable foundation for growing our user base and ensuring the system app's success in the competitive digital landscape.

ENGAGING CONTENT CREATORS: While influencers and micro-influencers play a critical role in our go-to-market strategy, content creators are equally significant to our plan. Content creators, even those without the vast follower counts of influencers, continuously fuel social media platforms with new and engaging material. These creators are already comfortable with generating video content and thus are well-positioned to leverage the unique functionalities of the system app. By targeting this group, we aim to cultivate a community of active users who consistently produce creative, high-quality produced movies. This, in turn, enhances the overall content offering on the app and attracts further users. Engagement strategies for content creators will include user-friendly onboarding materials, resources to boost their visibility on the platform, and incentives to encourage consistent creation and collaboration.

### Overview of Competitive Landscape.

The mobile video creation app market is a rapidly evolving and highly competitive space, brimming with innovation and creativity. As the consumption of short-form videos continues to rise, driven by platforms like TikTok, Instagram Reels, and YouTube Shorts, the demand for robust and easy-to-use video creation tools has seen a parallel increase.

Key players in the market include apps like TikTok, Snapchat, and Instagram, which have in-built video editing and creation tools. While primarily social media platforms, their native video creation and editing functionalities make them indirect competitors in this space.

There's also a subset of platforms specifically tailored towards more professional video creation, including Adobe Premiere Rush and InShot. These offer advanced editing features and appeal to creators looking to produce more polished and high-quality content.

While there are several platforms offering video creation capabilities, few focus on collaborative short film creation. However, some platforms provide similar features and could be considered direct competitors.

COLLAB (BY FACEBOOK): Facebook's Collab app allows users to create, watch, and mix and match original videos, making collaborative video creation possible. However, it focuses on music video collaborations rather than short films, distinguishing it from the system.

1 SECOND EVERYDAY (1SE): 1 Second Everyday is a video diary app that allows users to capture one second of footage every day, creating a compilation over time that forms a personal and unique video narrative. While it encourages user creativity and regular video creation, it does not offer the collaborative, structured filmmaking focus provided by the system. Users of 1SE create their own personal stories, whereas the system according to the present invention fosters a community of collaborative short film creation.

TONGAL: Tongal is a platform connecting writers, directors, and production companies to create original video content. Although it facilitates collaboration in film creation, it targets professionals and lacks the user-friendly, democratizing aspect of the mobile-first approach of the present invention.

Some platforms, while not offering the same collaborative short film creation feature, still compete for the same target audience's attention and time.

TIKTOK, FACEBOOK, INSTAGRAM, AND SNAPCHAT: Although these platforms are primarily social media apps, their in-built video creation and editing tools allow users to create short, engaging video content. The user-generated content aspect of these platforms does not include a structured, collaborative filmmaking focus.

YOUTUBE: While not a collaborative platform, YouTube's popularity as a platform for sharing and consuming videos could make it a potential competitor. Users can create their short films and share them on YouTube, although without the collaborative features that the present invention offers.

### Competitive Advantage of the System

COLLABORATIVE FILMMAKING: The core functionality revolves around collaborative short film creation. Unlike platforms focused on individual content creation, the system fosters a community of creators where each user has a distinct role (Director, Actor, etc.), thus democratizing the film creation process.

GLOBAL CASTING AND OPEN-CALL ACTING: The system provides an avenue for anyone, anywhere in the world, to become an actor in a film project. This not only broadens the talent pool available to Directors but also creates unique opportunities for users to participate in film projects they would otherwise not have access to.

DAILY ACTING COMPETITION: The system includes daily acting competition. Users can contribute to a scene of the daily produced movie created by admins. These scenes are voted on by the public, with awards given for the top 5 produced movies and top 5 Scenes. This encourages regular engagement and content creation while providing a platform for actors to gain recognition.

STRUCTURED FILM CREATION AND EDITING: The system's ‘Direct’ feature guides Directors through a structured process of film creation, including scene building, casting, and post-production selections. This structure is lacking in most other video creation apps and gives the system a unique standing.

AI-POWERED CREATIVE ASSISTANCE: the system's AI-powered tool that assists in generating movie ideas or scripts is a unique feature that enhances user creativity and simplifies the creative process.

IN-APP MONETIZATION: With the system's in-app currency, users can monetize their participation, which can be an enticing feature for both influencers and content creators.

FAN ENGAGEMENT FEATURES: The ‘Fan Twist’ feature offers an additional layer of engagement, enabling fans to add their unique spins to a movie and create their versions. This feature not only enhances user interaction but also aids in content diversification.

### BRIEF DESCRIPTION OF DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a diagram showing a movie production system employed for the production of a movie according to the present invention.

FIG. 2 is diagram showing the movie stitching algorithm of the movie production system of FIG. 1 according to the present invention.

FIG. 3 is a flowchart illustrating a method for implementing the movie stitching algorithm of FIG. 2.

FIG. 4 is an illustration of a display device showing an operational sequence that may be performed when implementing the method of FIG. 3 according to the present invention.

FIG. 5 is a flowchart illustrating a method for implementing a built-in virality mechanism, known as the K-factor, in the Mozaik app of the movie production system of FIG. 1 according to the present invention.

FIG. 6 is an illustration of a display device showing an operational sequence that may be performed when implementing the method of FIG. 3 according to the present invention.

FIG. 7A is a flowchart illustrating a method of implementing a movie production system of FIG. 1, according to some embodiments of the present disclosure.

FIG. 7B is a flowchart extending from FIG. 7A and further illustrating the method of implementing the movie production system of FIG. 1, according to some embodiments of the present disclosure.

### DETAILED DESCRIPTION OF THE INVENTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

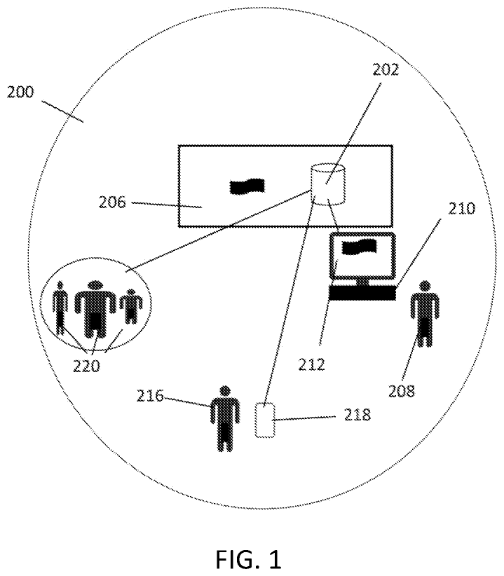

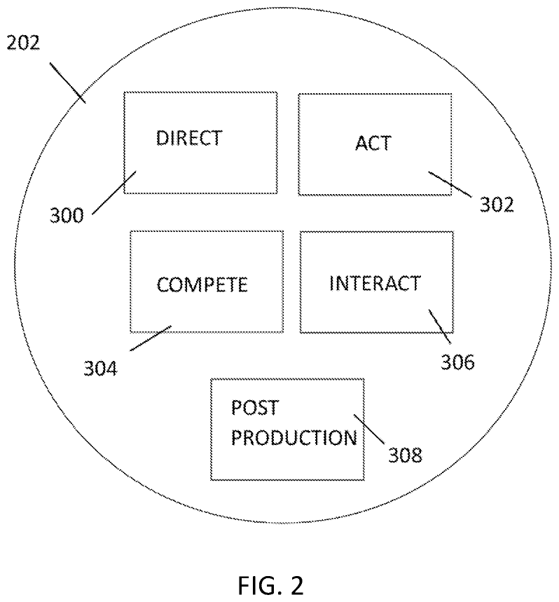

Referring now to the drawings FIGS. 1-2, and more particularly to FIG. 1, there is shown a functional system diagram 200 for the instant invention. A movie production system 200 includes hardware 210 for running the system 200 and a graphical interface 212 for providing software interaction. The movie production system 200 includes a movie stitching algorithm 202 as shown in FIG. 2. The movie stitching algorithm 202 includes a direct algorithm 300 for guiding directors 208 in the production of a movie and an act algorithm 302 for users 216 to participate in open-call casting, claiming scenes and contributing in user created film portions. The movie stitching algorithm 202 includes a compete algorithm 304 for providing daily acting competition for the actors 220 and an interact algorithm 306 for allowing the director 208 to create a director's cut and for users 216, through a mobile or computing device 218 to add content or plot twists and an automated post-production algorithm 308 for applying the director chosen post-production features, including background music, scene transitions, background images, and filters. The movie production system 200 is an advanced movie-stitching system which combines individual scenes submitted by actors 220 following the sequence laid out by a director during the production process. The movie stitching algorithm 202 may be cloud based 206.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

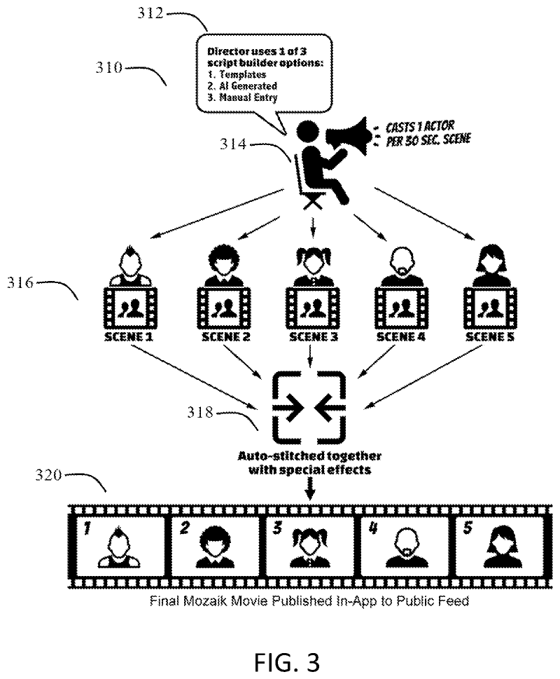

FIG. 3 is a flowchart of an example method 310 for implementing the movie stitching algorithm illustrated in FIG. 2 within the system app. At block 312, within the filmmaking process of the app's system, the director has the option to utilize one of three script builder options: templates, AI-generated scripts, and/or manually entered scripts. At block 314, the director casts one actor per every 30-second scene, for example, adhering to the specified duration. For instance, if a scene is slated to last 30 seconds, one actor is assigned to portray the characters within that scene. Furthermore, at block 316, there may be a plurality of actors, each associated with a multitude of individual scenes, contributing to the complexity and depth of the movie. Subsequently, at block 318, the app automatically stitches together the plurality of scenes, incorporating special effects as specified by the director. Finally, at block 320, the completed Mozaik movie is published within the app, making it accessible to users via a public feed. This technical process exemplifies the systematic workflow involved in creating and sharing movies on the platform, ensuring efficiency and coherence throughout each stage of production.

As noted above, central to this system is an advanced movie-stitching algorithm that integrates individual scenes provided by actors into a cohesive narrative, adhering to the sequence determined by the Director during the creation process. Furthermore, the app incorporates automated post-production algorithms, streamlining the editing process significantly. After the scenes are stitched together, the software automatically applies the Director's selected post-production features, such as background music, scene transitions, background images, and filters. This functionality simplifies the post-production workflow and ensures a polished, professional appearance for every movie produced on the platform.

In implementations, upon completion of the movie, the software initiates an automated process where it publishes the movie to the public feed. Simultaneously, it notifies both the Director and the actors involved that their collaborative effort has resulted in a finished product ready for viewing. Additionally, a link is provided for immediate access, creating an exciting moment of unveiling for all participants involved in the movie creation process. This integration of movie stitching, post-production editing, and automated sharing not only enhances the efficiency of the filmmaking process but also provides a rewarding and engaging experience for users.

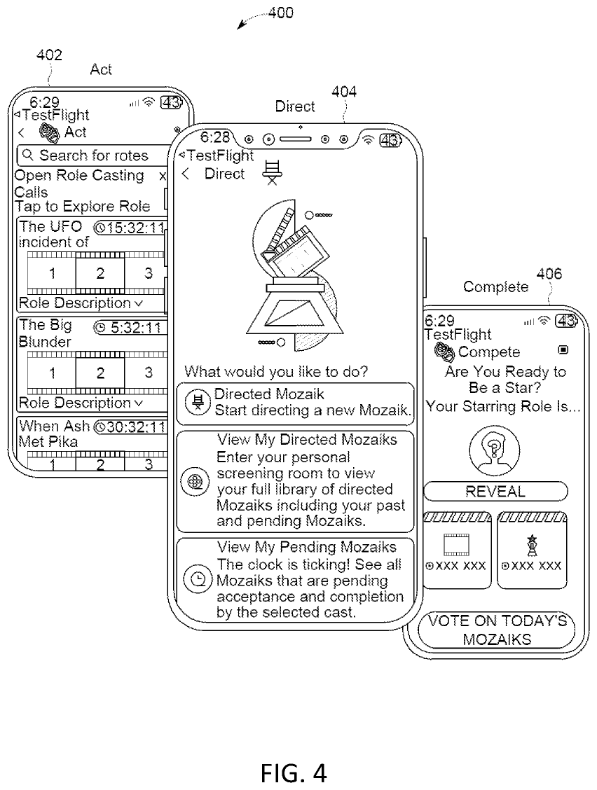

FIG. 4 illustrates an example of a display device 400 showing an operational sequence that may be performed when implementing the method of FIG. 3. For example, display device 400 implements an act feature 402 within the app to facilitate open-call casting to enable users to participate in casting decisions for roles that Directors have opened to the public. Users have the opportunity to browse through available roles, selecting and “claiming” an unclaimed scene that they wish to portray. Once claimed, users can film their parts and submit them for integration into the final Mozaik Movie. This feature serves as a valuable platform for aspiring actors, allowing them to showcase their talent and actively contribute to a diverse range of projects. By engaging in open-call casting, users can immerse themselves in the filmmaking process and collaborate with Directors and fellow actors to create compelling and inclusive Mozaik Movies.

In another example, display device 400 implements a direct feature 404 within the app to facilitate an intuitive wizard designed to facilitate the comprehensive process of creating a unique Mozaik Movie. Within this feature, Directors are guided through various steps, starting with the option to utilize an AI-powered tool for generating movie ideas or scripts, offering a solid foundation for the creative process. Additionally, Directors can define the movie's scenes, with each scene limited to a maximum duration of 30 seconds. Furthermore, the Direct feature allows Directors to pre-select elements for the post-production phase, such as background music, background images, scene transitions, and filter effects, forming a post-production template for automated completion.

As noted above, the wizard integrated into the Direct feature of the Mozaik app serves as a user-friendly and intuitive tool designed to guide Directors through the process of creating their unique Mozaik Movie. It provides a step-by-step interface that simplifies the otherwise complex process of film creation, making it accessible even to users with limited filmmaking experience. The wizard typically starts by prompting the Director to input basic details about their project, such as the title of the movie and a brief synopsis. As the Director progresses through the wizard, they are presented with various options and choices that help shape the direction of their movie. For instance, they may be given the option to use an AI-powered tool for generating movie ideas or scripts, providing a starting point for their creative journey. Additionally, the wizard allows the Director to define the scenes of their movie, specifying details such as location, characters involved, and the overall narrative arc. Furthermore, the wizard enables Directors to pre-select elements for the post-production phase, such as background music, background images, scene transitions, and filter effects. These selections form a post-production template that guides the automated completion of post-production tasks once all scenes have been shot and uploaded by the actors.

Once the scenes are laid out and the post-production template is set, Directors proceed to cast each role to actors. This casting process can be either closed, with specific actors in mind, or open-ended, inviting any potential actor using the platform to audition for roles. To facilitate open-ended casting, available roles are posted on the public ACT page, enabling interested users to participate in the casting process. Overall, the Direct feature offers a streamlined and efficient method for creating short films, guiding Directors from the initial idea stage through to final production, enhancing the filmmaking process on the Mozaik platform.

In another example, display device 400 implements a complete feature 406 within the app to facilitate a daily competition into the user experience. For example, each day, users have the opportunity to engage in a unique competition by participating in a randomized scene selected by Mozaik administrators for inclusion in the daily Mozaik Movie. Once users complete their scenes and upload them to the platform, they receive notifications once the movie compilation is finalized for viewing. Subsequently, for a duration of 24 hours following the compilation, the public is invited to cast their votes on all submitted Mozaik Movies. At the culmination of the voting period, the top five Mozaik Movies and the top five scenes are prominently announced on the Daily Awards page. This recognition serves as a testament to the creativity and talent of the winners, fostering a sense of accomplishment and driving continued engagement and participation within the Mozaik community.

In example, the daily competition theme may include, but not be limited to, “Action-Packed Adventure.” Mozaik admins select a scene template aligned with this theme, incorporating elements like dynamic action sequences, complex camera movements, and intricate choreography. Users opting to participate are presented with this scene template and instructed to film their rendition of it. For instance, a user named John selects this competition and receives the designated scene template. John meticulously plans his scene, strategizing camera angles, actor movements, and special effects to align with the theme's requirements. Utilizing professional-grade equipment and software, John captures high-quality footage that highlights intense action sequences and captivating visual effects. Upon completing his scene, John uploads it to the Mozaik platform, where it becomes part of the daily Mozaik Movie compilation. Throughout the next 24 hours, users engage with the movie and cast their votes for their preferred scenes based on criteria such as creativity, execution, and adherence to the theme. Following the voting period, the Mozaik platform tallies the votes and identifies the top five Mozaik Movies and top five scenes. These results are publicly announced on the Daily Awards page, showcasing the winners and their respective contributions. In this example, the competition within the Mozaik app serves as a mechanism to stimulate user engagement, promote creativity, and foster a sense of community among participants. Through the use of technical features such as scene templates, voting mechanisms, and result announcements, the competition enhances the user experience and encourages continued participation within the platform.

A display device 400 can encompass a range of devices, including but not limited to, a smartphone, a computer, and/or a tablet. These devices typically feature a display, such as an LCD, OLED, or AMOLED screen, and may also include a touchscreen interface. For instance, a smartphone could feature a 6-inch AMOLED display with a capacitive touchscreen, allowing users to interact with the device through touch gestures. Similarly, a computer might include a 27-inch 4K UHD monitor with both a traditional display and an optional touch-sensitive layer, facilitating user interaction via a mouse, keyboard, or direct touch inputs. Additionally, a tablet could feature a 10-inch LCD screen with multitouch capabilities, enabling complex gesture-based navigation through its graphical user interface (GUI). Each of these devices incorporates a GUI designed to facilitate user interaction, providing a visual and interactive means for controlling the device and accessing its features and applications.

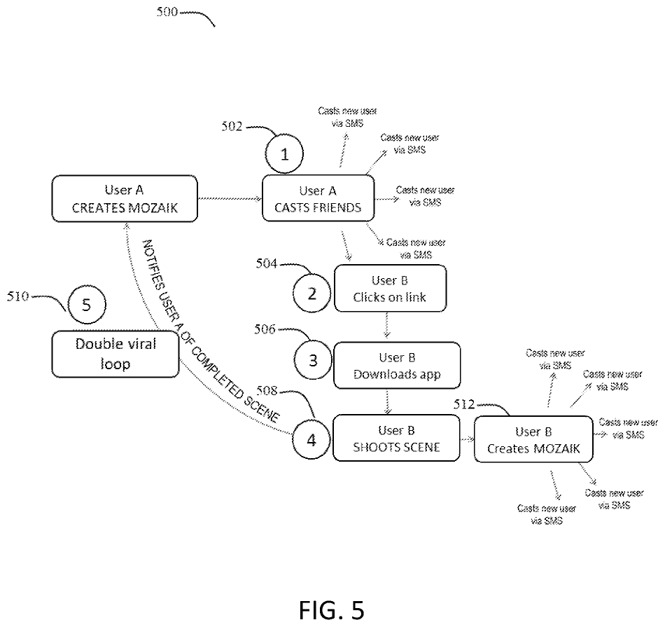

FIG. 5 illustrates a flowchart illustrating an example method for implementing a built-in virality mechanism 500, known as the K-factor, in the Mozaik app. At block 502, User A initiates the viral loop by casting friends to join the Mozaik app, leveraging SMS invitations to reach a plurality of new users. For instance, User A may send invitations to friends inviting them to participate in the platform's collaborative filmmaking process. At block 504, User B receives an invitation from User A and clicks on the provided link, expressing interest in joining the Mozaik community. At block 506, User B proceeds to download the Mozaik app onto their device, completing the initial step of the user acquisition process. Upon installation, User B gains access to the app's features and functionalities, paving the way for engagement in the filmmaking process. At block 508, User B actively participates in the platform's activities by shooting one or more scenes, contributing to the creation of Mozaik Movies. For example, User B may film a scene depicting a dramatic confrontation between characters or a visually stunning landscape shot. At block 510, a double viral loop mechanism is employed to notify User A of User B's completed scene, fostering continued engagement and interaction between users. This notification may include updates on User B's progress and achievements within the app, encouraging User A to further participate in the collaborative filmmaking process. Finally, at block 512, User B takes on the role of a creator by crafting their own Mozaik and casting a plurality of new users via SMS invitations. User B invites friends and acquaintances to join the platform, expanding the user base and perpetuating the viral loop for continued growth and engagement.

As noted above, the K-factor measures how effectively current users bring new users to the platform, calculated by multiplying the average number of invites sent by each user by the conversion rate of those invites. In Mozaik, users are incentivized to invite friends and colleagues to join, participate in film projects, and vote on Mozaik Movies. This viral loop is amplified by the app's social and collaborative features, encouraging more interaction and community involvement, thereby accelerating user acquisition and engagement through network effects. Mozaik's K-Factor, a measure of its virality and user acquisition, is driven by several key technical features. Firstly, the platform's Invitation System enables users to effortlessly invite friends via social media, email, or direct messages, expanding its user base through outreach. Moreover, Mozaik employs Conversion Incentives, offering initial rewards like Mozaik Tickets to new users joining through invitations, thus increasing the likelihood of conversion from invitation to active user. Additionally, Completed Mozaik Movies can be shared across various social media platforms, leveraging existing user networks to attract more viewers and potential users, demonstrating the platform's Social Sharing functionality.

Furthermore, collaborative features including, but not limited to, cloning and fan twists encourage existing users to involve others in the filmmaking process, fostering a collaborative environment that amplifies virality. To facilitate the integration of new users, Mozaik employs SMS casting alerts, sending notifications when users cast their friends for roles and providing deep links for quick app installation and initiation of the shooting process. Finally, engagement rewards incentivize users who successfully invite others and actively engage in collaborative projects, encouraging continued user growth and participation within the platform. These technical features collectively contribute to Mozaik's K-Factor, driving virality and user acquisition.

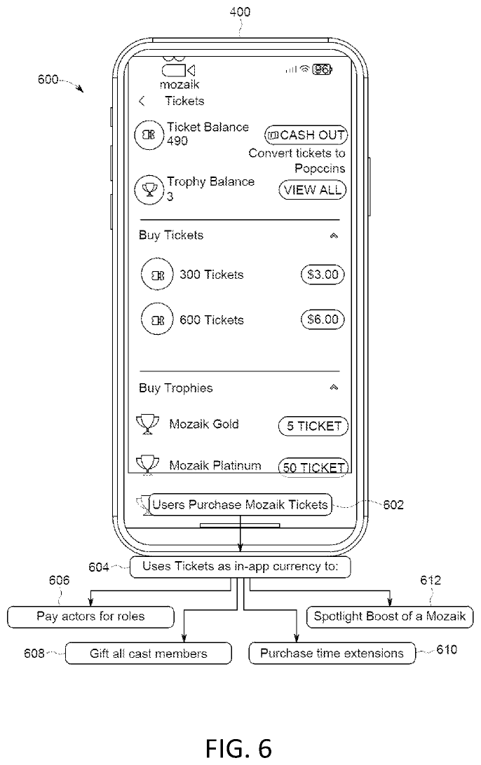

FIG. 6 illustrates the display device 400 showing an example operational sequence 600 that may be performed when implementing the method of FIG. 3. At block 602, users acquire Mozaik Tickets through various purchase mechanisms available within the app. For example, users can buy tickets via in-app purchases using credit cards, PayPal, or app store credits. At block 604, these Mozaik Tickets function as the app's in-app currency, facilitating a wide range of transactions. At block 606, one type of transaction involves compensating actors for their roles in Mozaik Movies. For instance, a director might use tickets to pay high-profile influencers to participate in a film project, providing an incentive for their involvement. At block 608, another transaction option allows users to gift Mozaik Tickets to all cast members of a movie, offering a form of recognition and appreciation for their performance and contribution. At block 610, users can also use Mozaik Tickets to purchase time extensions, such as extending the deadline for submitting scenes or providing additional time for post-production editing. This flexibility can be crucial for ensuring high-quality content creation. At block 612, a further transaction option enables users to use Mozaik Tickets to purchase a spotlight boost for their Mozaik Movie, enhancing its visibility on the platform and attracting a larger audience. This feature can be particularly valuable for new users seeking to increase their reach and engagement within the Mozaik community.

In implementations, the in-app economy and monetization strategy of the Mozaik app employs the use of Mozaik Tickets and PopCoins. For example, users can earn or purchase Mozaik Tickets, which can be used to appreciate movies, gift to cast members, or entice top talent for roles. The equitable distribution system ensures that all gifts must be given to the entire cast, so each member receives an equal value for gifts. This fosters a sense of community and recognition within the app, incentivizing participation and interaction. Tickets may be converted into PopCoins, which can then be converted to real money, providing an additional monetization pathway for users. This in-app economy not only encourages user engagement but also offers a viable avenue for actors and directors to monetize their creativity and contributions.

As noted above, users have the opportunity to earn or purchase Mozaik Movie Tickets, the platform's native currency, and utilize them to express appreciation for their preferred Mozaik Movies. Users can gift these tickets to cast members, providing a tangible form of recognition and reward for their creative contributions. Moreover, Directors within the app have the option to leverage Mozaik Tickets as incentives to attract top-tier actors or influencers to participate in their Mozaik Movies. This functionality not only empowers Directors to enlist high-profile talent but also serves as a monetization avenue for actors and influencers, who can receive compensation in the form of Mozaik Tickets for their involvement. To augment the interactive experience, users can also utilize Mozaik Tickets to purchase digital gifts, which they can then bestow upon their favorite cast members.

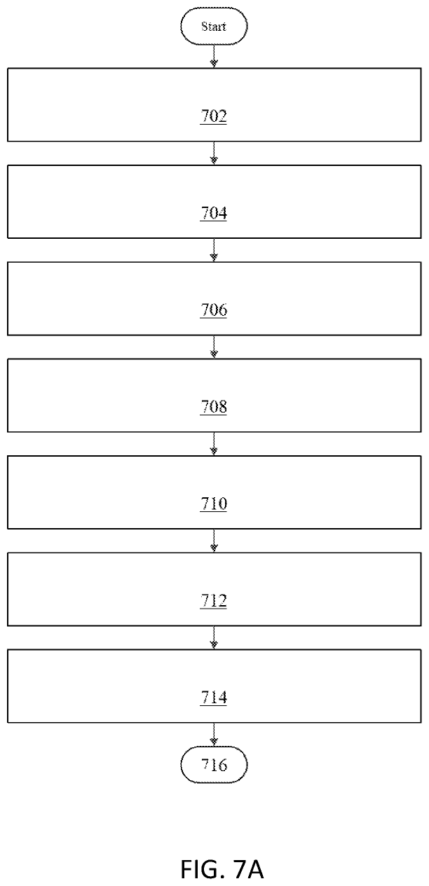

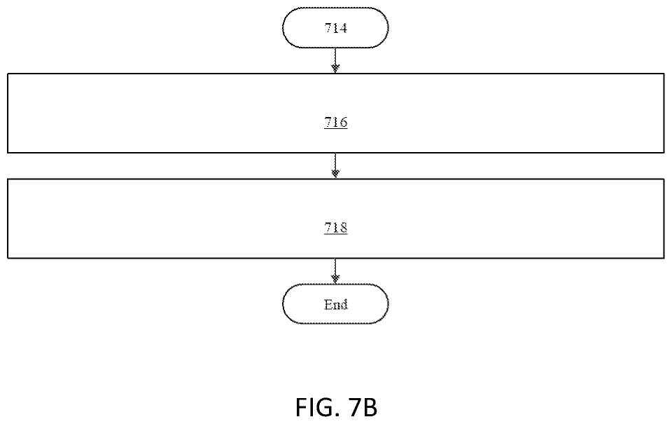

FIGS. 7A to 7B are flowcharts that describe a method of implementing a short film production system, according to some embodiments of the present disclosure. In some embodiments, at block 702, the method may include providing a memory circuit storing computer executable instructions. At block 704, the method may include providing a movie-stitching algorithm. At block 706, the method may include providing a processing device. At block 708, the method may include inviting one or more users via a communication protocol. At block 710, the method may include generating a link of an app of the short film production system.

In some embodiments, at block 712, the method may include generating a first movie script. At block 714, the method may include receiving one or more scenes, based on the first movie script, from the one or more users. At block 716, the method may include combining, using the movie-stitching algorithm, the one or more scenes into a first version of a movie based on the first movie script. At block 718, the method may include monitoring data of the first version of the movie. Execution of the computer executable instructions by the processing device, causes the processing device to perform the steps of, the method may include performing one or more additional steps. The app of the short film production system may be configured for a new user to download.

In some aspects, the techniques described herein relate to a computing device to implement a short film production system, including: a memory circuit storing computer executable instructions; a movie-stitching algorithm; and a processing device, wherein execution of the computer executable instructions by the processing device, causes the processing device to: invite one or more users via a communication protocol; generate a link of an app of the short film production system and wherein the app of the short film production system is configured for a new user to download; generate a first movie script; receive one or more scenes, based on the first movie script, from the one or more users; combine, using the movie-stitching algorithm, the one or more scenes into a first movie based on the first movie script; and monitor data of the first movie.

In some aspects, the techniques described herein relate to a computing device, wherein the communication protocol is a short message service (SMS).

In some aspects, the techniques described herein relate to a computing device, wherein the processing device causes the processing device to: measure, via a K-factor, a rate at which the new user downloads the app of the short film production system; and provide the new user with a digital currency reward.

In some aspects, the techniques described herein relate to a computing device, wherein the processing device causes the processing device to: generate digital currency for an in-app transaction.

In some aspects, the techniques described herein relate to a computing device, wherein the digital currency is a ticket.

In some aspects, the techniques described herein relate to a computing device, wherein the processing device causes the processing device to: generate a second movie, using an interact algorithm, based on an addition of at least one scene to the first movie script.

In some aspects, the techniques described herein relate to a computing device, wherein the processing device causes the processing device to: determine, using a cloning algorithm, one or more parameters of the first movie script to be adjusted; and responsive to the adjustment of the first movie script, generate a second movie.

In some aspects, the techniques described herein relate to a computing device, wherein the one or more parameters is background music.

In some aspects, the techniques described herein relate to a computing device, wherein the one or more parameters is a scene transition.

In some aspects, the techniques described herein relate to a computing device, wherein the one or more parameters is a filter effect.

In some aspects, the techniques described herein relate to a computing device, wherein the one or more parameters is a background image.

In some aspects, the techniques described herein relate to a computing device, wherein the processing device causes the processing device to: responsive to monitoring the data of the first movie, activate a competition based on a quantity of votes for one or more scenes of the first movie.

In some aspects, the techniques described herein relate to a computing device, wherein the processing device causes the processing device to: publish the first movie to a public feed; and concurrently generates an alert to indicate a publication of the first movie.

In some aspects, the techniques described herein relate to a computing device, wherein the processing device causes the processing device to: determine, using an adaptive algorithm, one or more parameters to be dynamically adjusted; and responsive to the dynamic adjustment, generate a second movie, using an automated post-production algorithm.

In some aspects, the techniques described herein relate to a computing device, wherein the one or more parameters is background music.

In some aspects, the techniques described herein relate to a computing device, wherein the one or more parameters is a scene transition.

In some aspects, the techniques described herein relate to a computing device, wherein the one or more parameters is a filter effect.

In some aspects, the techniques described herein relate to a computing device, wherein the one or more parameters is a background image.

In some aspects, the techniques described herein relate to a method of implementing a short film production system, including: providing a memory circuit storing computer executable instructions; providing a movie-stitching algorithm; and providing a processing device, wherein execution of the computer executable instructions by the processing device, causes the processing device to perform the steps of: inviting one or more users via a communication protocol; generating a link of an app of the short film production system and wherein the app of the short film production system is configured for a new user to download; generating a first movie script; receiving one or more scenes, based on the first movie script, from the one or more users; combining, using the movie-stitching algorithm, the one or more scenes into a first version of a movie based on the first movie script; and monitoring data of the first version of the movie.

In some aspects, the techniques described herein relate to a movie production system including: hardware for running an application; and a movie stitching algorithm including: a direct algorithm for guiding a director in a production of a movie; an act algorithm for users to participate in open-call casting, claiming scenes and contributing in user created film portions; a compete algorithm for providing daily acting competition for one or more actors; an interact algorithm for allowing the director to produce a director's cut and for users to add content or plot twists; and an automated post-production algorithm for applying one or more post-production features, including background music, scene transitions, background images, and filters; wherein the movie production system is an advanced movie-stitching system which combines individual scenes submitted by actors following a sequence laid out by the director during the production of the movie.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A computing device to implement a short film production system, comprising:
a memory circuit storing computer executable instructions;
a movie-stitching algorithm; and
a processing device, wherein execution of the computer executable instructions by the processing device, causes the processing device to:
invite one or more users via a communication protocol;
generate a link of an app of the short film production system and wherein the app of the short film production system is configured for a new user to download;
generate a first movie script;
receive one or more scenes, based on the first movie script, from the one or more users;
combine, using the movie-stitching algorithm, the one or more scenes into a first movie based on the first movie script; and
monitor data of the first movie.

2. The computing device of claim 1, wherein the communication protocol is a short message service (SMS).

3. The computing device of claim 1, wherein the processing device causes the processing device to:
measure, via a K-factor, a rate at which the new user downloads the app of the short film production system; and
provide the new user with a digital currency reward.

4. The computing device of claim 1, wherein the processing device causes the processing device to:
generate digital currency for an in-app transaction.

5. The computing device of claim 4, wherein the digital currency is a ticket.

6. The computing device of claim 1, wherein the processing device causes the processing device to:
generate a second movie, using an interact algorithm, based on an addition of at least one scene to the first movie script.

7. The computing device of claim 1, wherein the processing device causes the processing device to:
determine, using a cloning algorithm, one or more parameters of the first movie script to be adjusted; and
responsive to the adjustment of the first movie script, generate a second movie.

8. The computing device of claim 7, wherein the one or more parameters is background music.

9. The computing device of claim 7, wherein the one or more parameters is a scene transition.

10. The computing device of claim 7, wherein the one or more parameters is a filter effect.

11. The computing device of claim 7, wherein the one or more parameters is a background image.

12. The computing device of claim 1, wherein the processing device causes the processing device to:
responsive to monitoring the data of the first movie, activate a competition based on a quantity of votes for one or more scenes of the first movie.

13. The computing device of claim 1, wherein the processing device causes the processing device to:
publish the first movie to a public feed; and
concurrently generates an alert to indicate a publication of the first movie.

14. The computing device of claim 1, wherein the processing device causes the processing device to:
determine, using an adaptive algorithm, one or more parameters to be dynamically adjusted; and
responsive to the dynamic adjustment, generate a second movie, using an automated post-production algorithm.

15. The computing device of claim 14, wherein the one or more parameters is background music.

16. The computing device of claim 14, wherein the one or more parameters is a scene transition.

17. The computing device of claim 14, wherein the one or more parameters is a filter effect.

18. The computing device of claim 14, wherein the one or more parameters is a background image.

19. A method of implementing a short film production system, comprising:
providing a memory circuit storing computer executable instructions;
providing a movie-stitching algorithm; and
providing a processing device, wherein execution of the computer executable instructions by the processing device, causes the processing device to perform the steps of:
inviting one or more users via a communication protocol;
generating a link of an app of the short film production system and wherein the app of the short film production system is configured for a new user to download;
generating a first movie script;
receiving one or more scenes, based on the first movie script, from the one or more users;
combining, using the movie-stitching algorithm, the one or more scenes into a first movie based on the first movie script; and
monitoring data of the first movie.

20. A movie production system comprising:
hardware for running an application; and
a movie stitching algorithm comprising:
a direct algorithm for guiding a director in a production of a movie;
an act algorithm for users to participate in open-call casting, claiming scenes and contributing in user created film portions;
a compete algorithm for providing daily acting competition for one or more actors;
an interact algorithm for allowing the director to produce a director's cut and for users to add content or plot twists; and
an automated post-production algorithm for applying one or more post-production features, including background music, scene transitions, background images, and filters;
wherein the movie production system is an advanced movie-stitching system which combines individual scenes submitted by actors following a sequence laid out by the director during the production of the movie.
